(19) United States
(12) Patent Application Publication
(10) Pub. No.: US 2018/0213845 A1
(43) Pub. Date: Aug. 2, 2018

(54) ATOMIZER AND AEROSOL GENERATING APPARATUS

(71) Applicant: JOYETECH EUROPE HOLDING GMBH, Zug (CH)

(72) Inventor: WEIHUA QIU, Changzhou City, Jiangsu Province (CN)

(21) Appl. No.: 15/536,647

(22) PCT Filed: Jun. 17, 2016
(86) PCT No.: PCT/CN2016/086296

§ 371 Date: Jun. 15, 2017

(30) Foreign Application Priority Data
Jun. 19, 2015 (CN) 201520426405.1

(51) Int. Cl. A24F 47/00; H05B 3/03

(52) U.S. Cl. CPC A24F 47/008; H05B 3/03

(57) ABSTRACT

An atomiser, comprising an upper cover (110), an air intake hole (115) being disposed in said upper cover (110), the upper cover (110) extending inward to form an inner connecting tube (117), a separating member (119) being disposed in the inner connecting tube (117), the separating member (119) separating the inner connecting tube (117) into an air intake channel (1171) and a vapour outlet channel (1173), the air intake hole (115) and the air intake channel (1171) being in communication; and an atomisation assembly (150), an atomisation cavity (163) being formed between the atomisation assembly (150) and the upper cover (110); the gas entering the atomisation cavity (163) via the air intake hole (115) and the air intake channel (1171) carries away the aerosol atomised by means of the atomisation assembly (150), and bypasses the separating member (119) to be released through the vapour outlet channel (1173). Also provided is an aerosol generating apparatus comprising said atomiser.

### TECHNICAL FIELD

The present application relates to aerosol generating apparatus, and more particularly to an atomizer capable of avoiding liquid leakage and an aerosol generating apparatus with the atomizer.

### BACKGROUND

On the market, current electronic cigarettes generally have the problem of liquid leakage. The reasons include many aspects, the main reason is that cigarette liquid easily leaks out from the liquid storage chamber through the atomizing assembly. When the cigarette liquid is leaking, on the one hand, the user may inhale the leaked cigarette liquid during smoking, accordingly affecting the user's smoking experience; on the other hand, the leaked cigarette liquid may arrive at the battery pack and/or the PCB board, thereby affecting the normal operation of the electronic cigarette.

In order to achieve the purpose of avoiding liquid leakage, most of the current electronic cigarettes are provided with additional leakproof structure. However, the leakproof structure is complicated, and the reliability is poor.

### SUMMARY

In view of the above problem, it is necessary to provide an atomizer capable of avoiding liquid leakage and an aerosol generating apparatus with the atomizer.

An atomizer includes a top cover and an atomizing assembly. The top cover is provided with an air intake hole. An inner connecting pipe extends inwards from the top cover. A separation member is provided in the inner connecting pipe. The separation member partitions the inner connecting pipe into an air inlet passage and a smoke outlet passage. The air intake hole communicates with the air inlet passage. An atomizing chamber is defined between the atomizing assembly and the top cover. The external air enters into the atomizing chamber from the air intake hole and the air inlet passage, carries the aerosol formed by atomizing by the atomizing assembly, and bypasses the separation member to discharge out through the smoke outlet passage.

In one embodiment, the top cover further includes a pipe body and a top cover main body connected to the pipe body, the air intake hole is defined in the pipe body.

In one embodiment, the inner connecting pipe is formed by extending from the pipe body towards an interior of the top cover main body.

In one embodiment, the separation member is approximately L-shaped.

In one embodiment, the separation member includes a first partition plate and a second partition plate connected to the first partition plate.

In one embodiment, one end of the first partition plate is firmly connected to an inner wall of the pipe body and located above the air intake hole, and the other end of the first partition plate is connected to the second partition plate.

In one embodiment, two opposite lateral sides of the second partition plate near the first partition plate are firmly connected to the inner wall of the pipe body and/or the inner connecting pipe, and a free end of the second partition plate that is far away from the first partition plate extends into the atomizing assembly.

In one embodiment, the top cover is detachably mounted to the atomizing assembly.

In one embodiment, the top cover and the atomizing assembly are mounted together by thread.

An aerosol generating apparatus includes either one of the above atomizers.

An atomizer includes a top cover and an atomizing assembly. The top cover is provided with an air intake hole. A separation member is provided in the top cover. The separation member partitions an interior of the top cover into an air inlet passage and a smoke outlet passage. The air intake hole communicates with the air inlet passage. An atomizing chamber is defined between the atomizing assembly and the top cover. The external air enters into the atomizing chamber from the air intake hole and the air inlet passage, carries the aerosol formed by atomizing by the atomizing assembly, and bypasses the separation member to discharge out through the smoke outlet passage.

In one embodiment, the top cover includes a pipe body and a top cover main body connected to the pipe body, the air intake hole is defined in the pipe body, an inner connecting pipe extends from the pipe body towards an interior of the top cover main body, the separation member is provided in the inner connecting pipe.

In one embodiment, the separation member is L-shaped.

In one embodiment, the separation member includes a first partition plate and a second partition plate connected to the first partition plate.

In one embodiment, one end of the first partition plate is firmly connected to an inner wall of the pipe body and located above the air intake hole, and the other end of the first partition plate is connected to the second partition plate.

In one embodiment, two opposite lateral sides of the second partition plate near the first partition plate are firmly connected to the inner wall of the pipe body and/or the inner connecting pipe, and a free end of the second partition plate that is far away from the first partition plate extends into the atomizing assembly.

In one embodiment, the top cover is detachably mounted to the atomizing assembly.

In one embodiment, the top cover and the atomizing assembly are mounted together by thread.

In one embodiment, the atomizer further includes a connecting ring, the connecting ring is disposed on the atomizing assembly, the connecting ring and the top cover is mounted together by thread.

An aerosol generating apparatus includes either one of the above atomizers.

The atomizer has the following advantages:

1. The air intake hole is provided at the top side of the atomizer, even near the inhaler. That is, the atomizer adopts the way of air intake from the top side, not the conventional way from the bottom side. Thus, it is not required to define an air intake hole at the bottom side of the atomizer, the bottom side of the atomizer is tightly sealed, so as to avoid the aerosol-forming liquid used to form the aerosol from leaking out.

2. The atomizer adopts the way of adding liquid from the top side, to further avoid the liquid leakage problem resulted due to a detachable connection between the atomizing assembly and the bottom cover.

3. The atomizer has a simple structure. It is not required to provide a complicated leakproof structure to resolve the liquid leakage problem.

4. The storage chamber is set around the atomizing assembly to spare more space, which can reduce the size of the whole atomizer and increase the volume of the storage chamber.

### BRIEF DESCRIPTION OF THE DRAWINGS

FIG. 1 is an isometric view of an atomizer according to an embodiment of the present application;

FIG. 2 is a front view of the atomizer of FIG. 1;

FIG. 3 is a cross sectional view of the atomizer of FIG. 2 along the line of A-A;

FIG. 4 is an isometric view of a top cover of the atomizer of FIG. 2; and

FIG. 5 is an exploded view of the atomizer of FIG. 1.

atomizer 100; inner tube 153;
top cover 110; atomizing seat 155;
bottom cover 130; atomizing pipe 156;
atomizing assembly 150; heating element 157;
pipe body 111; liquid guide element 159;
top cover main body 113; storage chamber 160;
air intake hole 115; conductive element 161;
inner connecting pipe 117; atomizing chamber 163;
separation member 119; top sealing element 165;
second partition plate 1193; connecting ring 170;
air inlet passage 1171; first insulator 167;
smoke outlet passage 1173; second insulator 169;
connecting end 133; pole contact element 168;
mounting hole 135; top sealing ring 181;
outer tube 151; bottom sealing ring 183;
first partition plate 1191; bottom cover main body 131;
window 1511; outer connecting pipe 120;
liquid inlet hole 1551.

### DETAILED DESCRIPTION OF PREFERRED EMBODIMENTS

In order to easily understand the purposes, characteristics and advantages of the present application, exemplary embodiments of the present application are described in detail with reference to the accompanying drawings. Many specific details are given in the following description to fully understand the present application, but the present application can be implemented by other ways different from the following description. A person in the art can make similar variations and improvements without departing from the spirit of the present application. Therefore, the present application is not restricted by the following concrete embodiments.

It should be noted that, when an element is referred to as being “mounted” to another element, it can be directly mounted to the other element, or mounted to the other element by intervening elements. When an element is referred to as being “connected” to another element, it can be directly connected to the other element, or connected to the other element by intervening elements.

Unless otherwise defined, all the technical terms in the present application have the meaning same to that understood by the technical person in the art. The terms in the description of the present application are only for the purpose of describing the specific embodiments, and are not intended to limit the present application. The use of the term “and/or” in the description includes any and all combinations of one or more of the listed items.

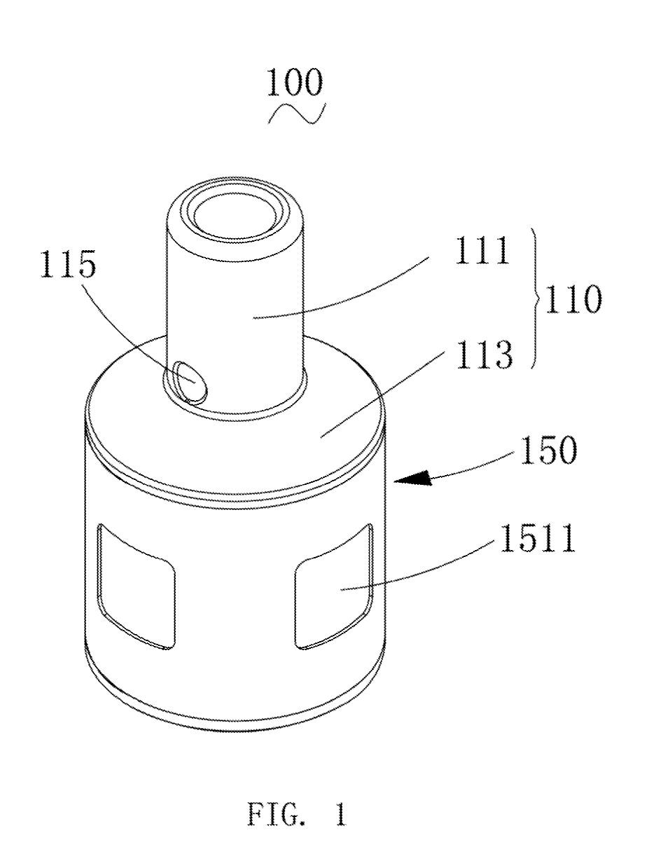

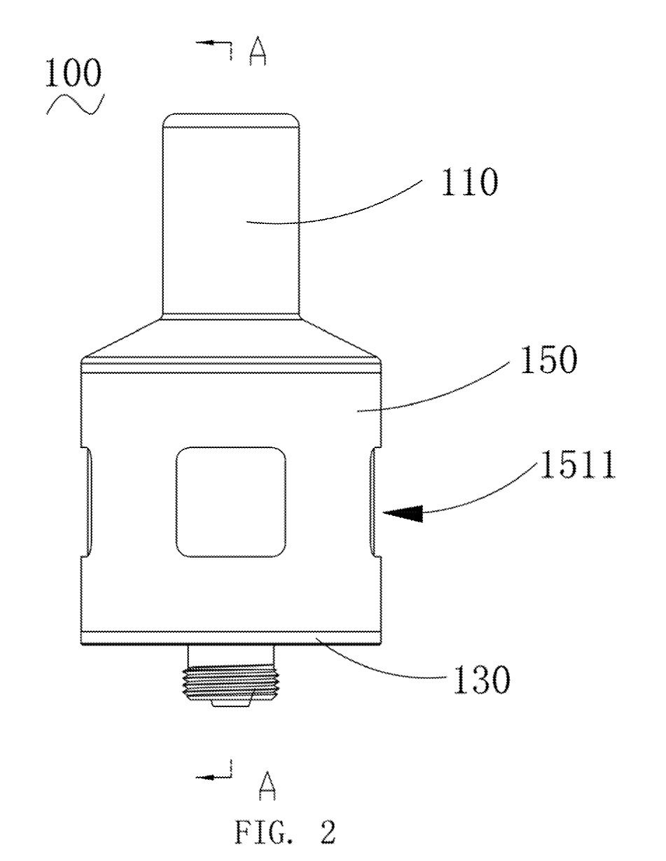

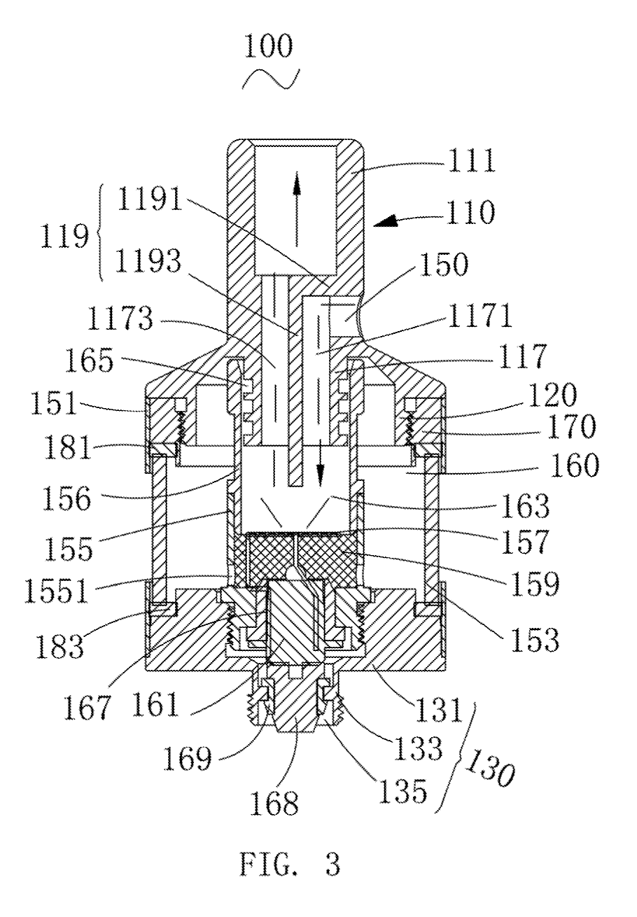

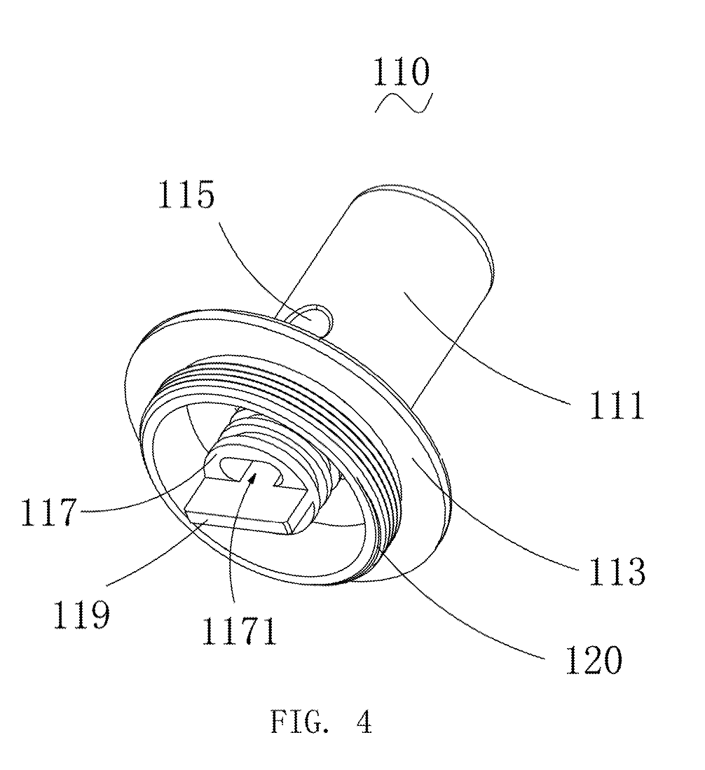

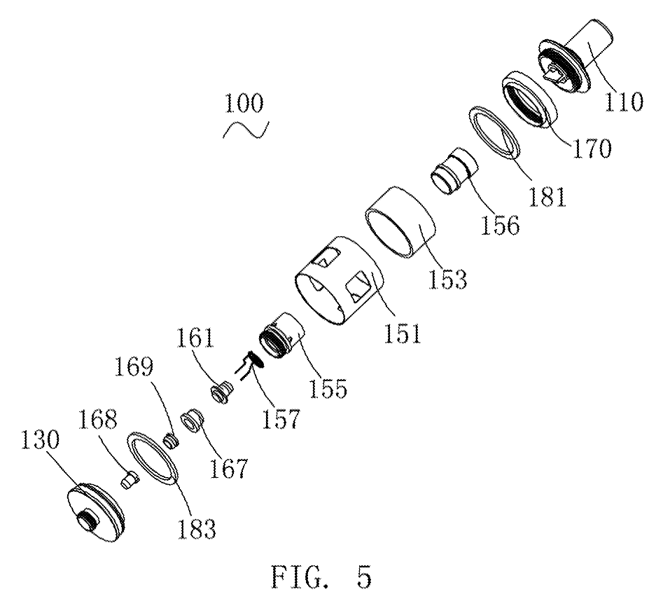

With reference to FIGS. 1-5, the present application provides an atomizer 100. The atomizer 100 includes a top cover 110, a bottom cover 130, and an atomizing assembly 150. The atomizing assembly 150 is disposed between the top cover 110 and the bottom cover 130.

The top cover 110 includes a pipe body 111, a top cover main body 113 connected to the pipe body 111, an air intake hole 115 defined in the pipe body 111, an inner connecting pipe 117, and a separation member 119 provided in the inner connecting pipe 117. The inner connecting pipe 117 is formed by extending from the pipe body 111 towards an interior of the top cover main body 113. The top cover main body 113 extends outwards from one end of the pipe body 111 as a trumpet-shaped or funnel-shaped flange.

In the embodiment, the free end (not labeled) of the pipe body 111 that is far away from the top cover main body 113 is itself an inhaler. It is understood that, in other embodiment, the free end of the pipe body 111 may be mounted to an inhaler (not shown), for the user to inhale the aerosol atomized by the atomizing assembly 150.

The air intake hole 115 and the inner connecting pipe 117 communicate with the atomizing assembly 150.

The separation member 119 is approximately L-shaped, including a first partition plate 1191 and a second partition plate 1193 connected to the first partition plate 1191. That is, the first partition plate 1191 and the second partition plate 119 are mounted to form an L shape. One end of the first partition plate 1191 is firmly connected to an inner wall of the pipe body 111 and located above the air intake hole 115. The other end of the first partition plate 1191 is connected to the second partition plate 1193. Two opposite lateral sides of the second partition plate 1193 near the first partition plate 1191 are firmly connected to the inner wall(s) of the pipe body 111 and/or the inner connecting pipe 117. A free end of the second partition plate 1193 that is far away from the first partition plate 1191 extends into the atomizing assembly 150. Thus, the separation member 119 partitions an interior of the inner connecting pipe 117 into an air inlet passage 1171 and a smoke outlet passage 1173, the air intake hole 115 and the smoke outlet passage 1173 are separated apart from each other, and the air intake hole 115 and the air inlet passage 1171 are communicated with each other. Under the user's suction, the external air flows through the air intake hole 115 and the air inlet passage 1171 sequentially, enters into the atomizing assembly 150, carries the aerosol formed by atomizing by the atomizing assembly 150, and bypasses the separation member 119 to discharge out through the smoke outlet passage 1173, for the user to inhale.

It is understood that, according to the actual requirements, the air intake hole 115 may also be defined in the top cover main body 113. Thus, the first partition plate 1191 and the second partition plate 1193 may be adjusted accordingly, so that the interior of the inner connecting pipe 117 is partitioned into the air inlet passage 1171 and the smoke outlet passage 1173, and the air intake hole 115 and the air inlet passage 1171 are communicated with each other.

In the embodiment, the first partition plate 1191 is semi-circular. The second partition plate 1193 is rectangular. The circular side edge of the first partition plate 1191 is firmly connected to the inner wall of the pipe body 111, the diameter side edge of the first partition plate 1191 is intersected with the second partition plate 1193.

The bottom cover 130 includes a bottom cover main body 131 and a connecting end 133 connected with the bottom cover main body 131. The connecting end 133 is used for connecting the atomizer 100 with a power source. In the embodiment, the connecting end 133 is provided with an outer thread, and the connecting end 133 is connected with a power source device (not shown) by the outer thread. The bottom cover 130 is further provided with a mounting hole 135 for receiving and mounting the atomizing assembly 150. In the present embodiment, the mounting hole 135 is generally trapezoidal.

The atomizing assembly 150 includes an outer tube 151, an inner tube 153, an atomizing seat 155, an atomizing pipe 156, a heating element 157, a liquid guide element 159, a conductive element 161, and an atomizing chamber 163. The outer tube 151 is disposed between the top cover 110 and the bottom cover 130. The inner tube 153 is disposed in the outer tube 151. The atomizing seat 155 is disposed in the inner tube 153 and installed on the bottom cover 130. In the embodiment, the atomizing seat 155 is detachably installed on the bottom cover 130, for facilitating the replacement of the atomizing assembly 150. The heating element 157, the liquid guide element 159 and the conductive element 161 are all disposed in the atomizing seat 155. The atomizing pipe 156 and the atomizing seat 155 are partially superposed with each other, to form the atomizing chamber 163. In the embodiment, the atomizing seat 155 is detachably mounted in the mounting hole 135 and threaded with the bottom cover 130.

It is understood that, according to the actual requirements, the atomizing pipe 156 and the atomizing seat 155 may be integrally formed.

Two opposite ends of the inner tube 153 are respectively abutted against the top cover 110 and the bottom cover 130. One end of the atomizing pipe 156 is hermetically mounted with the inner connecting pipe 117. One end of the atomizing seat 155 that is far away from the atomizing pipe 156 is detachably installed on the bottom cover 130. Thus, the top cover 110, the bottom cover 130, the inner tube 153, the atomizing pipe 156 and the atomizing seat 155 cooperatively define a storage chamber 160 for hermetically storing an aerosol-forming liquid which can be atomized to form the aerosol.

In the embodiment, the outer tube 151 is provided with a window 1511 for the user to observe remaining volume of the aerosol-forming liquid used to form the aerosol through the window 1511. In the embodiment, the outer tube 151 is made of an opaque material, the inner tube 153 is made of a transparent material.

It is understood that, according to the actual requirements, the outer tube 151 can be omitted.

In the embodiment, a top sealing element 165 is provided between the inner connecting pipe 117 and the atomizing pipe 156, to avoid the air inside the atomizing chamber 163, the air inlet passage 1171 and the smoke outlet passage 1173 from leaking out, and further to avoid the air from entering into the storage chamber 160 to form a negative pressure.

In the embodiment, the atomizer 100 further includes a connecting ring 170. The connecting ring 170 is disposed between the top cover 110 and the outer tube 153. The connecting ring 170 is mounted with the top cover 110 by thread, to enable the top cover 110 to detachably mount with the atomizing assembly 150. In the embodiment, the top cover 110 further includes an outer connecting pipe 120 mounted with the connecting ring 170 by thread. The outer connecting pipe 120 is a pipe body extending from the top cover main body 113 towards the atomizing assembly 150 along an axial direction of the top cover 110. The outer connecting pipe 120 and the inner connecting pipe 117 are coaxially arranged, with the outer connecting pipe 120 being disposed at an outer side of the inner connecting pipe 117. In the embodiment, one end of the outer tube 151 is mounted to the connecting ring 170, the other end of the outer tube 151 is mounted to the bottom cover 130. Further, in order to avoid liquid leakage, the outer tube 151 is tightly mounted to the bottom cover 130.

It is understood that, according to the actual requirements, the outer connecting pipe 120 of the top cover 110 may be directly detachably mounted with the outer tube 153 and/or the inner tube 151, so that the top cover 110 may be detached from the atomizing assembly 150. Thus, the connecting ring 170 can be omitted.

The heating element 157 contacts with the liquid guide element 159. The atomizing seat 155 is provided with at least a liquid inlet hole 1551 near the bottom cover 130. The liquid guide element 159 abuts against an inner wall of the atomizing seat 155 and covers the liquid inlet hole 1551. The aerosol-forming liquid used to form the aerosol enters into the atomizing chamber 163 via the liquid inlet hole 1551, and is absorbed by the liquid guide element 159, transferred to the heating element 158 and atomized by the heating element 158.

The conductive element 161 is embedded in one end of the atomizing seat 155 near the bottom cover 130 and electrically connected with the heating element 157. A first insulator 167 is disposed between the conductive element 161 and the atomizing seat 155 for insulating them to form positive and negative poles, wherein the conductive element 161 is the positive pole, the bottom cover 130 and the atomizing seat 155 are the negative pole.

The atomizer 100 further includes a pole contact element 168 and a second insulator 169 disposed between the pole contact element 168 and the bottom cover 130. One end of the pole contact element 168 is electrically connected with the conductive element 161, the other end of the pole contact element 168 is electrically connected with a power source device (not shown). The second insulator 169 insulates the pole contact element 168 acting as a positive pole from the bottom cover 130 acting as a negative pole.

The atomizer 100 further includes a top sealing ring 181 and a bottom sealing ring 183. The top sealing ring 181 is disposed between the connecting ring 170 and the inner tube 153, the bottom sealing ring 183 is disposed between the bottom cover 130 and the inner tube 153, for sealing the storage chamber 160 and avoiding the aerosol-forming liquid used to form the aerosol from leaking out.

In operation, under the user's suction, the external air comes to contact with the heating element 157 via the air intake hole 115 and the air inlet passage 1171, carries the aerosol formed by atomizing by the heating element 157, then bypasses the separation member 119 to discharge out through the smoke outlet passage 1173, for the user to inhale.

When it is required to add the aerosol-forming liquid used to form the aerosol, the outer connecting pipe 120 is detached from the connecting ring 170, such that the top cover 110 is removed away from the atomizing assembly 150, and the user can add the aerosol-forming liquid used to form the aerosol into the storage chamber 160.

The atomizer 100 of the present application has the following advantages:

1. The air intake hole 115 is provided at the top side of the atomizer 100, even near the inhaler. That is, the atomizer 100 adopts the way of air intake from the top side, not the conventional way from the bottom side. Thus, it is not required to define an air intake hole at the bottom side of the atomizer 100, the bottom side of the atomizer 100 is tightly sealed, so as to avoid the aerosol-forming liquid used to form the aerosol from leaking out from the storage chamber 160 via the inner tube 153 and/or the outer tube 151.

2. The atomizer 100 adopts the way of adding liquid from the top side, to further avoid the liquid leakage problem resulted due to a detachable connection between the atomizing assembly 150 and the bottom cover 130.

3. The atomizer 100 has a simple structure. It is not required to provide a complicated leakproof structure to resolve the liquid leakage problem.

4. The storage chamber 160 is set around the atomizing assembly 150 to spare more space, which can reduce the size of the whole atomizer 100 and increase the volume of the storage chamber 160.

The present application further provides an aerosol generating apparatus with the above atomizer 100.

The above embodiments described in detail are several embodiments of the present application only, and should not be deemed as limitations to the scope of the present application. It should be noted that variations and improvements will become apparent to those skilled in the art to which the present application pertains without departing from its spirit. Therefore, the scope of the present application is defined by the appended claims.

What is claimed is:

1. An atomizer, comprising:
a top cover (110), the top cover (110) being provided with an air intake hole (115), an inner connecting pipe (117) extending inwards from the top cover (110), a separation member (119) being provided in the inner connecting pipe (117), the separation member (119) partitioning the inner connecting pipe (117) into an air inlet passage (1171) and a smoke outlet passage (1173), the air intake hole (115) communicating with the air inlet passage (1171); and
an atomizing assembly (150), an atomizing chamber (163) being defined between the atomizing assembly (150) and the top cover (110);
wherein the external air enters into the atomizing chamber (163) from the air intake hole (115) and the air inlet passage (1171), carries the aerosol formed by atomizing by the atomizing assembly (150), and bypasses the separation member (119) to discharge out through the smoke outlet passage (1173).

2. The atomizer of claim 1, wherein the top cover (110) further comprises a pipe body (111) and a top cover main body (113) connected to the pipe body (111), the air intake hole (115) is defined in the pipe body (111).

3. The atomizer of claim 2, wherein the inner connecting pipe (117) is formed by extending from the pipe body (111) towards an interior of the top cover main body (113).

4. The atomizer of either one of claims 1 to 3, wherein the separation member (119) is approximately L-shaped.

5. The atomizer of either one of claims 1 to 3, wherein the separation member (119) comprises a first partition plate (1191) and a second partition plate (1193) connected to the first partition plate (1191).

6. The atomizer of claim 5, wherein one end of the first partition plate (1191) is firmly connected to an inner wall of the pipe body (111) and located above the air intake hole (115), and the other end of the first partition plate (1191) is connected to the second partition plate (1193).

7. The atomizer of claim 6, wherein two opposite lateral sides of the second partition plate (1193) near the first partition plate (1191) are firmly connected to the inner wall(s) of the pipe body (111) and/or the inner connecting pipe (117), and a free end of the second partition plate (1193) that is far away from the first partition plate (1191) extends into the atomizing assembly (150).

8. The atomizer of claim 7, wherein the top cover (110) is detachably mounted to the atomizing assembly (150).

9. The atomizer of claim 8, wherein the top cover (110) and the atomizing assembly (150) are mounted together by thread.

10. An aerosol generating apparatus comprising the atomizer of either one of claims 1 to 9.

11. An atomizer, comprising a top cover (110) and an atomizing assembly (150), the top cover (110) being provided with an air intake hole (115), a separation member (119) being provided in the top cover (110), the separation member (119) partitioning an interior of the top cover (110) into an air inlet passage (1171) and a smoke outlet passage (1173), the air intake hole (115) communicating with the air inlet passage (1171), an atomizing chamber (163) being defined between the atomizing assembly (150) and the top cover (110), wherein the external air enters into the atomizing chamber (163) from the air intake hole (115) and the air inlet passage (1171), carries the aerosol formed by atomizing by the atomizing assembly (150), and bypasses the separation member (119) to discharge out through the smoke outlet passage (1173).

12. The atomizer of claim 11, wherein the top cover (110) comprises a pipe body (111) and a top cover main body (113) connected to the pipe body (111), the air intake hole (115) is defined in the pipe body (111), an inner connecting pipe (117) extends from the pipe body (111) towards an interior of the top cover main body (113), the separation member (119) is provided in the inner connecting pipe (117).

13. The atomizer of claim 12, wherein the separation member (119) is L-shaped.

14. The atomizer of claim 12, wherein the separation member (119) comprises a first partition plate (1191) and a second partition plate (1193) connected to the first partition plate (1191).

15. The atomizer of claim 14, wherein one end of the first partition plate (1191) is firmly connected to an inner wall of the pipe body (111) and located above the air intake hole (115), and the other end of the first partition plate (1191) is connected to the second partition plate (1193).

16. The atomizer of claim 15, wherein two opposite lateral sides of the second partition plate (1193) near the first partition plate (1191) are firmly connected to the inner wall(s) of the pipe body (111) and/or the inner connecting pipe (117), and a free end of the second partition plate (1193) that is far away from the first partition plate (1191) extends into the atomizing assembly (150).

17. The atomizer of claim 11, wherein the top cover (110) is detachably mounted to the atomizing assembly (150).

18. The atomizer of claim 17, wherein the top cover (110) and the atomizing assembly (150) are mounted together by thread.

19. The atomizer of claim 17, wherein the atomizer further comprises a connecting ring (170), the connecting ring (170) is disposed on the atomizing assembly (150), the connecting ring (170) and the top cover (110) is mounted together by thread.

20. An aerosol generating apparatus comprising the atomizer of either one of claims 11 to 19.
